(19) United States
(12) Patent Application Publication
(10) Pub. No.: US 2004/0168712 A1
(43) Pub. Date: Sep. 2, 2004

(54) Method for cleaning semiconductor manufacturing system

(75) Inventors: Wei-Sheng Chao, Kaohsiung (TW); Chi-Hui Lin, Kaohsiung (TW); Chuang-I Chen, Tainan Hsien (TW); Goang-Cheng Chang, Kaohsiung (TW); Chao-Kai Hsieh, Pingtung (TW); Hsin-Cheng Huang, Tainan (TW); Cheng-Jye Chu, Kaohsiung (TW)

Correspondence Address: Troxell Law Office PLLC, Suite 1404, 5205 Leesburg Pike, Falls Church, VA, 22041, US

(73) Assignee: Nanmat Technology Co., Ltd.

(21) Appl. No.: 10/786,118

(22) Filed: Feb. 26, 2004

(30) Foreign Application Priority Data
Feb. 27, 2003 (TW) 092104123

(51) Int. Cl. B08B 3/00

(52) U.S. Cl. 134/22.18; 134/22.1; 134/22.11; 134/22.12; 134/22.15

(57) ABSTRACT

This invention is a method for cleaning a semiconductor manufacturing system, which passes a highly volatile liquid agent through the system to remove the impurities and to dissolve chemicals used in the system. The cleaning agent dissolves and washes the chemicals out of the system to keep the chemicals from combining with moisture in the air and forming oxide particles. By washing with a liquid, residual gases and impurities in the system are rapidly removed from the system. After washing the system, the cleaning agent is quickly dried because the cleaning agent is highly volatile. Thereby, the system is cleaned efficiently within a short time by using this method.

### BACKGROUND OF THE INVENTION

1. Field of the Invention

The present invention relates to a method for cleaning a semiconductor manufacturing system, and more particular a method that introduces high purity and highly volatile cleaning agents into the system to remove residual chemicals, waste gas and impurities from the system efficiently.

2. Description of Related Art

In semiconductor manufacturing or micro-processing procedures, gaps between circuit conductors are only sub-micrometers. Fine particles on the wafers often cause sneak or short circuits in the integrated circuits, which will cause the device to fail. Therefore, all semiconductor manufacturing systems have strict requirements for environmental cleanliness and high purity materials. For a standard clean degree “class-10”, only ten particles larger than 0.5 μm diameter can exist in any 1 cubic-inch volume.

Because chemical containers, pipes or other apparatus in the system are replaced so often, external (i.e. unclean) air goes into the system and mixes with the chemicals to affect the purity of the chemicals and even react with the chemicals to generate contaminant particles in the system. Therefore, the system has to be cleaned each time when any chemical container, pipes or other apparatus is replaced.

With reference to FIG., the process used in a conventional semiconductor manufacturing system comprise a chemical vapor deposition chamber (10) and multiple feed-in systems such as plasma-gas sources (a), carrier-gas sources (b), purge gas sources (c), at least one ampoule (20), etc. An ampoule (20) is mounted between the purge gas sources (c) and the carrier-gas sources (b) and contains a high purity chemical that mixes with carrier gases, is sent to the chemical vapor deposition chamber (10) and is deposited on a wafer. The ultra-pure chemical, e.g. tetrakis-dimethylamino titanium (TDMAT, Ti[N(CH₃)₂]₄), used in the deposition process in the system. When the tetrakis-dimethylamino titanium in the ampoule (20) runs out, the ampoule (20) has to be replaced with a new one. However, external air will enter the tubes when the ampoule (20) is disconnected from the system. When tetrakis-dimethylamino titanium in the system mixes with moisture in the air, titanium oxide particles are generated as a pollutant in the system. Therefore, the system has to be cleaned to remove the tetrakis-dimethylamino titanium residuals in the tube before the ampoule (20) is disconnected, and then one more time of cycling pump/purge to remove any moist air and titanium oxide particles happened after replacing the chemical-filled ampoule (20).

A conventional cleaning method in accordance with the prior art uses gases to clean the system. The purge-gas sources (c) inject nitrogen or helium gas into the system to blow chemicals and any contaminants away to a drain (d). Additionally, tubes in the system pass through a heating board (e) to heat the nitrogen or helium gas in the tubes and increase purging efficiency.

To remove chemical residuals and any contaminants, low-cost nitrogen gas is preferred and is introduced into the system. The conventional method is carried out individually in different sections of the system. However, nitrogen gas only purges out chemicals roughly in the tubes, which can not clean the system quickly and efficiently. Consequently, the method is slow and inefficient and requires three to four days to clean the entire system. For manufacturers, the conventional method is very high cost in terms of productivity.

The conventional method for purging semiconductor manufacturing systems still has a troublesome problem with regard to the use of high purity chemical for deposition on the semiconductors.

The present invention has arisen to mitigate or obviate the disadvantages of the conventional method of cleaning semiconductor manufacturing systems.

### SUMMARY OF THE INVENTION

The main objective of a method for purging a semiconductor manufacturing system in accordance with the present invention is to be able to clean the system quickly and efficiently.

Further benefits and advantages of the present invention will become apparent after a careful reading of the detailed description with appropriate reference to the attached drawings.

### BRIEF DESCRIPTION OF THE DRAWINGS

FIG. 1 is a flow diagram, wherein a high purity cleaning agent is introduced into a semiconductor manufacturing system from an ampoule to practice a method for cleaning the semiconductor manufacturing system in accordance with the present invention;

FIG. 2 is another flow diagram in FIG. 1, wherein nitrogen gas and the high purity cleaning agent are introduced into the system; and

FIG. 3 is still another flow diagram in FIG. 1; and

FIG. 4 is a flow diagram of conventional semiconductor manufacturing system in accordance with prior art.

### DETAILED DESCRIPTION OF THE INVENTION

A method for cleaning a semiconductor manufacturing system in accordance with the present invention uses highly volatile liquid cleaning agents flowing through the system to remove impurities and to dissolve chemicals used in the system and their by-products. Thereby, the system is cleaned up efficiently. The method comprising acts of opening optional one of the multiple sections in the system; introducing a high purity and highly volatile cleaning agent into the optional one of the multiple sections; washing the optional one of the multiple sections; and drying the optional one of the multiple sections.

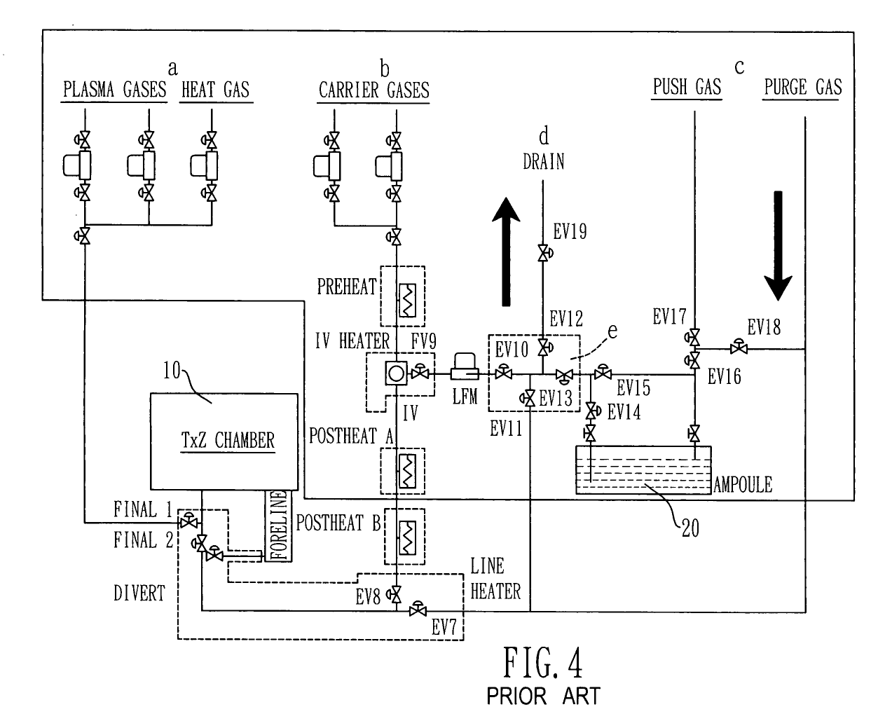

With reference to FIG. 4, the semiconductor manufacturing system cleaned by the method in accordance with the present invention is same as conventional one, has the same devices described in the description of the related art and comprises a chemical vapor deposition chamber (10) and multiple feed-in devices such as plasma-gas sources (a), carrier-gas sources (b), purge-gas sources (c), at least one ampoule (20), etc. Additionally, multiple valves (EV12, EV13, EV15, EV16, EV18, EV19) are mounted between the devices to control the cleaning agents and purge gases. An ampoule (20) is mounted between the purge sources (c) and the carrier-gas sources (b) and contains a high purity chemical that mixes with carrier gases from the carrier-gas sources (b), is sent to the chemical vapor deposition chamber (10) and is deposited on a semiconductor substrate.

Before using the method in the present invention, a purge gas such as nitrogen gas is introduced into the system to remove tetrakis-dimethylamino titanium (TDMAT, Ti[N(CH₃)₂]₄) roughly.

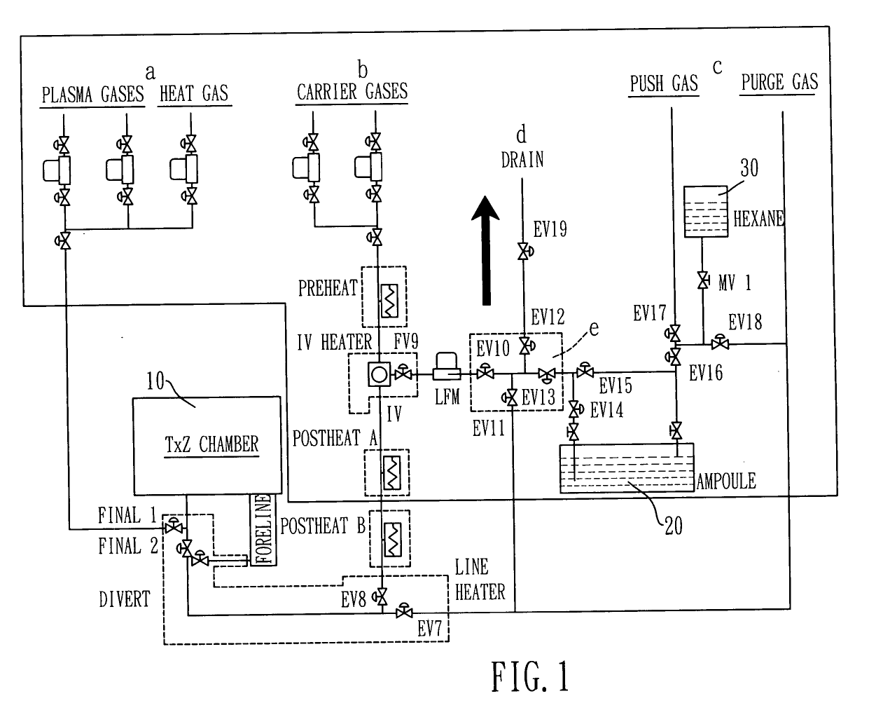

Then, as shown in FIG. 1, a storage container (30) accommodating a cleaning agent with high purity and highly volatile properties is connected to the system to introduce the cleaning agent into the system. The cleaning agent is hexane, iso-propanol, acetone, toluene, etc. that can dissolve tetrakis-dimethylamino titanium (TDMAT, Ti[N(CH₃)₂]₄).

Liquid hexane, acetone, iso-propanol, toluene, etc. in the tubes completely washes any impurities and residual material out of the system. In comparison with the conventional purge method that uses gaseous dilution and pressure, the method in accordance with the present invention can clean the system in a short time by washing instead of diluting. Hexane acetone, iso-propanol, toluene, etc. are highly volatile so the system dries quickly and can be re-started in short time. Furthermore, tetrakis-dimethylamino titanium (TDMAT, Ti[N(CH₃)₂]₄) is very dissoluble in hexane, acetone, iso-propanol, toluene, etc., which keeps tetrakis-dimethylamino titanium (TDMAT, Ti[N(CH₃)₂]₄) from combining with moisture in the air to generate oxide titanium particles. Therefore, tetrakis-dimethylamino titanium (TDMAT, Ti[N(CH₃)₂]₄) is drawn actively out of the system with the agent when the agent is discharged through the drain (d), which prevents the formation of the titanium oxide particles.

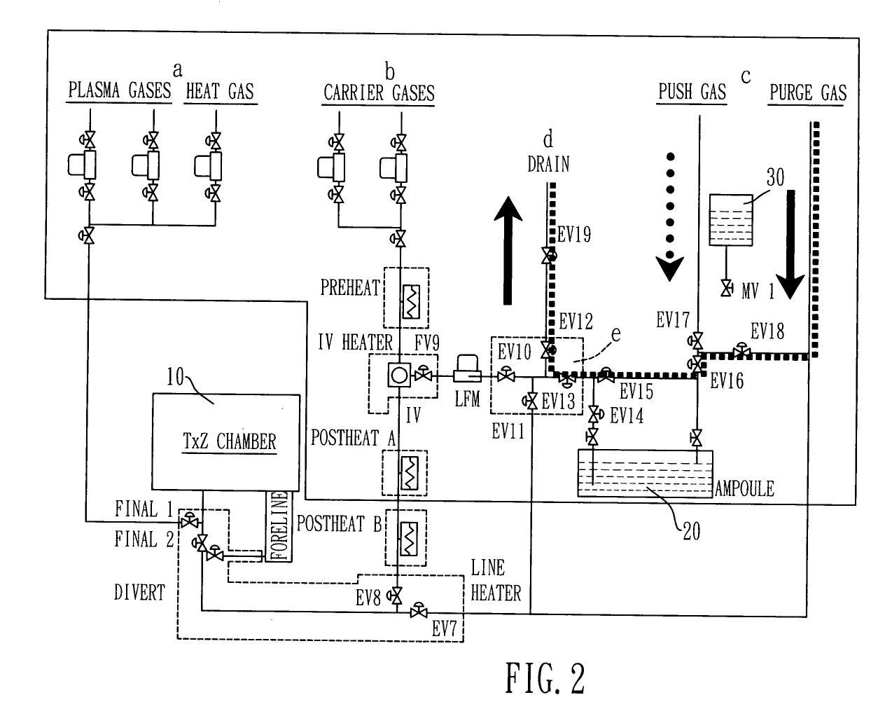

With reference to FIG. 2, the method also uses system pressurization gas to improve cleaning efficiency. Initially, valves (EV12, EV13, EV15, EV16, EV19) between the purging-gas sources (c) and the drain (d) are opened to allow liquid agent to remove any residual chemical in tubes. Then, the valve (EV18) to isolate the purging-gas sources (c) is opened to allow the system pressurization gas to enter the system and push liquid agent out to accelerate the cleaning speed. The system pressurization gas is selectively introduced into the system at the same time, or after the cleaning agent is introduced, to push the cleaning agent through the system. The system pressurization gas is either nitrogen or helium and is preferably helium.

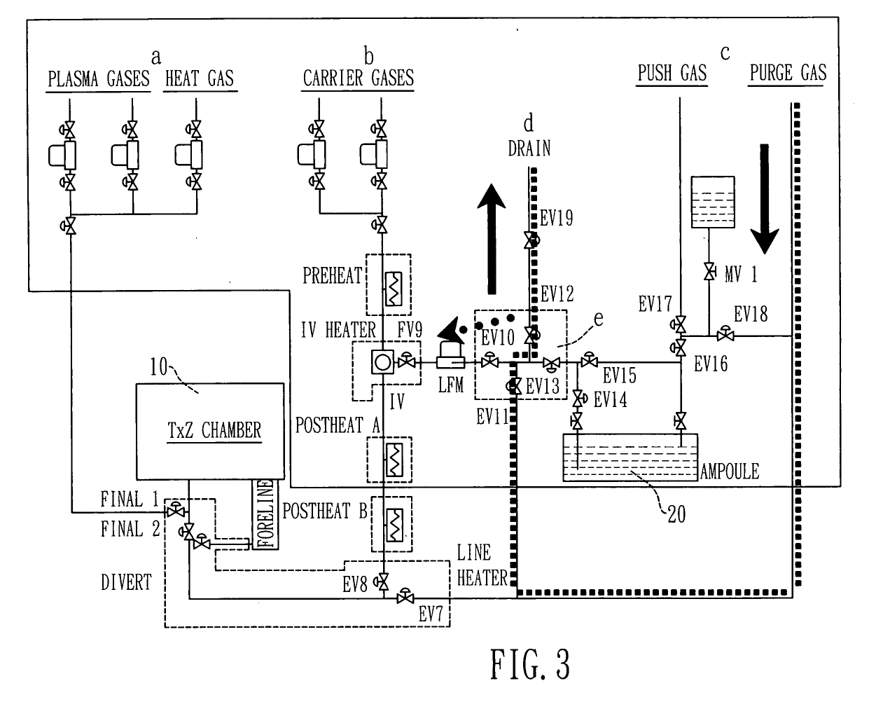

Different sections in the system can be cleaned by the same method of using cleaning agents and purge gas. With reference to FIG. 3, another section bypassing the ampoule (20) is cleaned by opening a valve (EV11) to allow nitrogen gas to flow through this section to clean the system with the purging agent or to allow helium gas to flow through to dry the system. Additionally, a heating plate (e) in the system can heat the purge gas or the system pressurization gas to accelerate the cleaning speed.

Anyone knowledgeable in semiconductor manufacturing easily understands how to use the valves to isolate and clean different sections of the system in different stages.

Characteristics of the cleaning agent are particularly important to the effectiveness of the method. Specifically the cleaning agent should be a liquid, highly soluble to the chemicals used to manufacture semiconductors and volatile. In the method described, the purging agent is a liquid that washes chemicals and contaminants out of the system more efficiently than a gas thereby shortening the cleaning time. Because the cleaning agent is highly soluble to chemicals used to manufacture semiconductors, the residual raw material such as tetrakis-dimethylamino titanium (TDMAT, Ti[N(CH₃)₂]₄) is easily dissolved in the cleaning agent to prevent generating titanium oxide particles. Moreover, the highly volatile characteristic of the cleaning agent allows the system to be dried quickly.

When compared to the conventional purging method, the cleaning method in accordance with the present invention shortens the operational time for each cleaning process from 3 to 4 days to about 3 hours. Thus, lots manufacturing time is significantly reduced, which benefits the manufacturers.

Although the invention has been explained in relation to its preferred embodiment, one should understand that many other possible modifications and variations can be made without departing from the spirit and scope of the invention as hereinafter claimed.

What is claimed is:

1. A method for cleaning a semiconductor manufacturing system having multiple sections of tubes, the method comprising acts of:
opening one of the multiple sections of tubes in the system;
introducing a high purity and highly volatile cleaning agent into the optional one of the multiple sections of tubes;
washing the optional section of tubes with the high purity and highly volatile cleaning agent; and
drying the optional section of tubes;
wherein, the method uses the high purity and highly volatile cleaning agent in form of liquid to wash the system and is adapted to dissolve and wash out chemicals used in the system.

2. The method as claimed in claim 1, wherein a purge gas is introduced into the system to purge the system before introducing the high purity and highly volatile cleaning agent.

3. The method as claimed in claim 1, wherein a purge gas is introduced into the system at the same time of introducing the high purity and highly volatile cleaning agent.

4. The method as claimed in claim 1, wherein a system pressurization gas is introduced into the system after introducing the high purity and highly volatile cleaning agent.

5. The method as claimed in claim 2, wherein a system pressurization gas is introduced into the system after introducing the high purity and highly volatile cleaning agent.

6. The method as claimed in claim 3, wherein a system pressurization gas is introduced into the system after introducing the high purity and highly volatile cleaning agent.

7. The method as claimed in claim 5, wherein the purging agent is selected from the group comprising hexane, acetone, iso-propanol and toluene.

8. The method as claimed in claim 7, wherein the purge gas is nitrogen.

9. The method as claimed in claim 8, wherein the system pressurization gas is selected from the group comprising helium and nitrogen.

10. The method as claimed in claim 9, wherein the purge gas and the system pressurization gas are heated to speed up cleaning of the system.
